(19) United States
(12) Patent Application Publication
(10) Pub. No.: US 2004/0215723 A1
(43) Pub. Date: Oct. 28, 2004

(54) Methods and apparatus for facilitating online presence based actions

(75) Inventor: Lovleen Chadha, San Diego, CA (US)

Correspondence Address: Siemens Corporation, Attn: Elsa Keller, Legal Administrator, Intellectual Property Department, 170 Wood Avenue South, Iselin, NJ, 08830, US

(73) Assignees: Siemens Information; Communication Mobile LLC

(21) Appl. No.: 10/420,272

(22) Filed: Apr. 22, 2003

(51) Int. Cl. G06F 15/16

(52) U.S. Cl. 709/206

(57) ABSTRACT

A system, method, apparatus, means, and computer program code for facilitating online presence based actions. According to some embodiments of the present invention, an entity's presence status may trigger an action in accordance with a rule established by a user. A system or apparatus may include a task client application adapted to initiate an action upon receipt of instructions from a task manager. The task manager may receive presence status information for the entity from a presence client, determine if a rule has been satisfied by the entity based on the entity's presence status, and provide the instructions or information to the task client application regarding the action.

### BACKGROUND OF THE INVENTION

The present invention relates to a method and apparatus for facilitating online presence based actions.

Personal organizers and schedulers may associate tasks or reminders with time based events. For example, a user's personal digital assistant (PDA) may include an organizer having an integrated scheduler, calendar, address book, to-do list, etc. that will generate audible and/or visual reminders of upcoming meetings, telephone calls, appointments, etc. Thus, a scheduled event or task may trigger the organizer to provide the reminder at the appropriate time. That is, the reminder is triggered by a specific time that the user has specifically associated with the event or task.

While such time based reminders may be helpful, they are limited in regards to providing reminders based on other criteria. It is desirable to provide methods and apparatus that provide reminders or perform other actions based on the online presence of an entity.

### SUMMARY OF THE INVENTION

Embodiments of the present invention provide a system, method, apparatus, means, and computer program code for facilitating online presence based actions. According to embodiments of the present invention, an entity's online presence status may trigger an action in accordance with a rule established by a user. A system or apparatus may include a task client application adapted to initiate an action upon receipt of instructions from a task manager. The task manager may receive presence status information for the entity from a presence client, determine if a rule has been satisfied by the entity based on the entity's presence status; and provide the instructions or information to the task client application regarding the action.

Additional features of the invention shall be set forth in part in the description that follows, and in part will become apparent to those skilled in the art upon examination of the following or may be learned by the practice of the invention. According to some embodiments of the present invention, an apparatus may include a task client application, the task client application adapted to initiate an action upon receipt of information regarding the action; a presence client, the presence client capable of receiving presence status information regarding an entity; and a task manager in communication with the task client application and the presence client, the task manager having access to at least one rule associated with the entity's presence status, being capable of determining when the rule is satisfied, and being capable of providing information regarding the action to the task client application. In addition, in some embodiments, the apparatus may include a presence manager in communication with the presence client and capable of determining the entity's presence status and providing the presence status information to the presence client and/or a subsystem in communication with the task client application and adapted to receive information from the task client application regarding the action. The online presence status of the entity may be based on or include online presence of the entity, absence of an online presence of the entity, a change of the entity from online presence to absence, or a change of the entity from absence to online presence. In some embodiments, the apparatus might not include the task client application, or the task client application may be part of a separate apparatus or system.

Also in accordance with some embodiments of the present invention, a method for facilitating an action based on an entity's online presence status may include determining a rule associated with an online presence status of an entity; determining an action associated with the rule; determining if the rule has been satisfied; and initiating the action if the rule has been satisfied. As an alternative, in some embodiments, a method for facilitating an action based on an entity's online presence status may include associating a rule with an online presence status of an entity; associating an action with the rule; determining that the rule has been satisfied; and initiating the action if the rule has been satisfied. In some embodiments, the methods described herein may be implemented by a device, apparatus, computer code, or other means.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a general block diagram illustrating concepts of presence management;

FIG. 2 is a block diagram of a first embodiment of a system in accordance with the present invention;

FIG. 3 is a block diagram of a second embodiment of a system in accordance with the present invention;

FIG. 4 is a block diagram of a third embodiment of a system in accordance with the present invention;

FIG. 5 is a block diagram of a fourth embodiment of a system in accordance with the present invention;

FIG. 6 is a block diagram of a fifth embodiment of a system in accordance with the present invention;

FIG. 7 is a flowchart of a first embodiment of a method in accordance with the present invention; and

FIG. 8 is a block diagram of components for an embodiment of a client device of FIGS. 3 and 4.

### DETAILED DESCRIPTION

There is a market opportunity for systems, computer code, means and methods that facilitate online presence based reminders. Some embodiments of the present invention provide such capabilities, by associating user defined actions with the online presence of an entity. As used herein, a “user” may be, include, or refer to a person, a software application or process, or a device. Similarly, as used herein, an “entity” may be, include, or refer to a person, a software application or process, or a device. For example, an entity or user may refer to a person logged onto a wired or wireless network, a device that is capable or interacting with a wired or wireless network, an application or process executing on a device that is capable of interacting with a wired or wireless network. For purposes of ease of explanation, the term “user” is used herein to refer to a person, software application or process, or device that establishes a rule and the term “entity” is used herein to refer to a person, software application or process, or device whose online presence, absence, or transition triggers application of the rule. That is, the online presence of an entity, online absence of an entity, or transition in the online presence of an entity may trigger an action in accordance with a rule established by a user. In some situations, a user and an entity may be the same person, software application or process, or device. As used herein, the term “presence” is used to include or refer to the online presence of an entity on a network, which may be or include a wired and/or wireless network.

In some embodiments, each entity may be associated with one or more entity identifiers so that the entity can be recognized or identified. For example, in some embodiments, an entity identifier may be, include, or refer to one or more of the following: a login ID, an email address, a URL (Uniform Resource Locator) or URI (Uniform Resource Identifier), a phone number, an Ethernet or other computer or electronic address, an IP (Internet Protocol) address, an IMEI (International Mobile station Equipment Identity) or ESN (Emergency Service Number), a globally unique ID (GUID) as used by COM/CORBA to identify applications, a buddy identifier in an instant messaging (IM) system, etc. As a more specific example, instant messaging domains generally refer to the identifiers as “buddy” and list of identifiers are referred to as “buddy lists”. In some embodiments, determining an online presence of an entity may include determining or establishing an identifier for the entity.

There are may ways in which the online presence of an entity can be determined and the present invention is not limited or tied to any particular protocol or technology for detecting online presence of an entity. For example, in some embodiments, one or more of the following protocols or techniques or other presence management methods might be deployed or used: Instant Message and Presence Protocol (IMPP); Simple Instant Messaging and Presence Service; Session Initiation Protocol (SIP); Simple Network Management Protocol (SNMP); busy tone and dial tone on a telephone system or network; “who” and “ps” commands in a UNIX system or network; Home Location Register (HLR) and Visitor Location Register (VLR) as used in mobile phone networks to detect presence of a subscriber; pilot beacons and related control messages being broadcasted by cellular base stations indicating availability of service; discovery mechanisms inherent in Bluetooth compliant devices; etc.

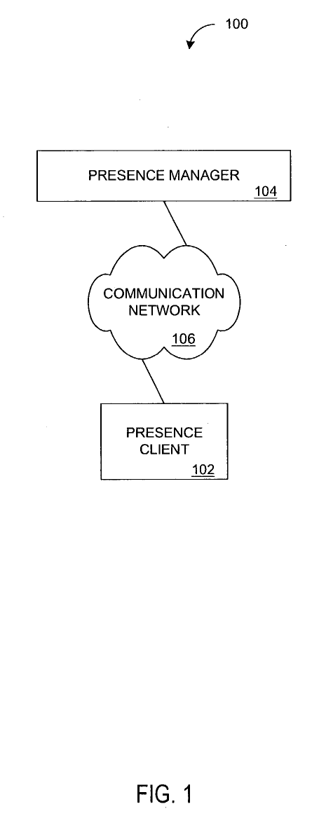

Now referring to FIG. 1, a system 100 is illustrated that includes a presence client 102 (i.e., an entity) that may be in communication with a presence manager 104 via a communication network 106. The system 100 is typical of many instant messaging configurations or applications. Typically, presence management includes support for a capability, event, condition, etc. that defines the presence or absence of an entity and a mechanism for conveying this information to devices, people, applications, or other clients who are interested in tracking or knowing about the presence of the entity.

In an instant messaging system, the presence manager 104 may be or operate on a server or other device that keeps track of one or more entities (e.g., the presence client 102). Thus, the presence manager 104 may be or include one or more software applications or processes installed, resident, or operating on a server. In some embodiments, a server can comprise a single device or computer, a host or mainframe computer, a networked set or group of devices or computers, a mainframe or host computer, a workstation, etc.

In some embodiments, the presence client 102 may be or include one or more software applications or processes installed, resident, or operating on a user device. In some embodiments, a user device may be or include a personal computer, portable computer, mobile or fixed user station, workstation, network terminal or server, telephone, beeper, kiosk, dumb terminal, personal digital assistant, facsimile machine, two-way pager, radio, cable set-top box, etc.

The communications network 106 might be or include the Internet, the World Wide Web, or some other public or private computer, cable, telephone, client/server, peer-to-peer, or communications network or intranet, as will be described in further detail below. The communications network 106 illustrated in FIG. 1 is meant only to be generally representative of cable, computer, telephone, peer-to-peer or other communication networks for purposes of elaboration and explanation of the present invention and other devices, presence clients, networks, etc. may be connected to the communications network 106 without departing from the scope of the present invention. The communications network 106 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. Moreover, as used herein, communications include those enabled by wired or wireless technology.

In some embodiments, the presence client 102 may use a “heartbeat” mechanism or protocol to indicate its presence to the presence manager 104 or otherwise send its presence information to the presence manager 104. The presence manager 106 can then make presence information associated with presence client 102 available to other presence clients (not illustrated in FIG. 1). The presence client 102 may use a periodic or some other schedule that can adapt to changes in the condition of the network 106 when determining when to send presence information to the presence manager 104.

In some embodiments, transfer of presence information from the presence manager 104 to presence clients may employ a pull mechanism or a push mechanism. The presence client 102 may maintain a buddy list indicating the other presence clients that are of interest to the presence client 102. In a pull mechanism, the presence client 102 periodically may check the presence manager 104 to determine if there has been any change in online status of the presence clients in the buddy list. In a push mechanism, the presence client 102 sends its buddy list to the presence manager 104 and the presence manager 104 notifies the presence client 102 whenever there is a change in the online status of any of the presence clients in the buddy list. In either mechanism, the presence client 102 is able to makes its online status known to other presence clients and to keep track of the online status of other presence clients.

In some embodiments, the presence client 102 may execute as a software process in an account associated with a particular user on a device (e.g., a PDA). Thus, the online presence of an individual or a device may be tracked. In some other embodiments, the presence client 102 may provide additional presence information, such as the identity of the individual, the identity of the device, the configuration of the device (e.g., does the device have a CD-ROM present), the availability of the device, etc. As more specific examples, a presence client installed on a device may be able to determine and report if the device is switched on, if the device is connected to a network, if the device is experiencing a failure or problem, if the device has come back into operation, etc.

As previously discussed above, the online presence of an entity (as established by a presence client associated with the entity), online absence of an entity, or transition in the online presence of an entity may trigger an action established by a user in accordance with one or more rules. Thus, in some embodiments, rule information may be or include information regarding the action to be initiated, instigated, or otherwise started when the rule is satisfied, information regarding how the action is to be implemented, information necessary to complete the action (e.g., email addresses, telephone numbers, messages, URLs, routing information, entity identifiers, application or device settings or identifiers).

In some embodiments, an action may be, include, involve, or refer to one or more of the following: presentation of a prompt or message to an entity or user; initiation of a user-defined or other pre-specified task or action on a device or in a network; launching, pausing, resuming, or stopping of an application on a device; dialing of a telephone number, sending of a message (e.g., an email message, an instant message, SMS, EMS, MMS) with or without a user defined or otherwise pre-specified address; starting of browser software with or without a user defined or otherwise pre-specified URL; switching of a device to a particular mode or configuration; activating or setting a specific profile, setting, or feature on a device or application; enabling or disabling or one or more menus or commands; starting, stopping, pausing, or resuming a download, database query, file transfer, etc.; or some other activity.

Actions are triggered or otherwise initiated by rules that are established by one or more users and that relate to the online presence, absence, or transition of one or more entities. There are many different types of rules that may be used. For example, a rule may be based on the presence of an entity (e.g., presence of a specific user currently logged onto a server may trigger a user defined action). As another example, a rule may be based on the absence of an entity (e.g., an absence of a specific user from being logged onto a server, a device that is yet to be switched on). As a third example, a rule may be based on the transition in the status of an entity (e.g., a transition from “present” to “absent” of a device, such as a printer server going down or otherwise becoming unavailable, may trigger a user defined action).

As illustrated by the examples above, an entity's online presence status or change in online presence status may trigger one or more action. Online presence status of an entity may include one or more of the following: online presence of the entity, an absence of an online presence of the entity, a change of the entity from online presence to absence, and a change of the entity from absence to online presence.

In some embodiments, the presence based rules may be combined with rules based on date, time, entity position or location (as may be determined by GPS, zip code, area code, mailing address, or other location determination technique or system). Also, in some embodiments, a time threshold might be associated with one or more rules. For example, a rule may require that a printer server be down for fifteen minutes before a designated action is initiated or executed.

In some embodiments, a rule might be associated with more than one entity. For example, a rule may trigger an action when the online presence of either Entity A or Entity B is detected. As another example, a rule may trigger an action only when the online presence of both Entity A and Entity B is detected.

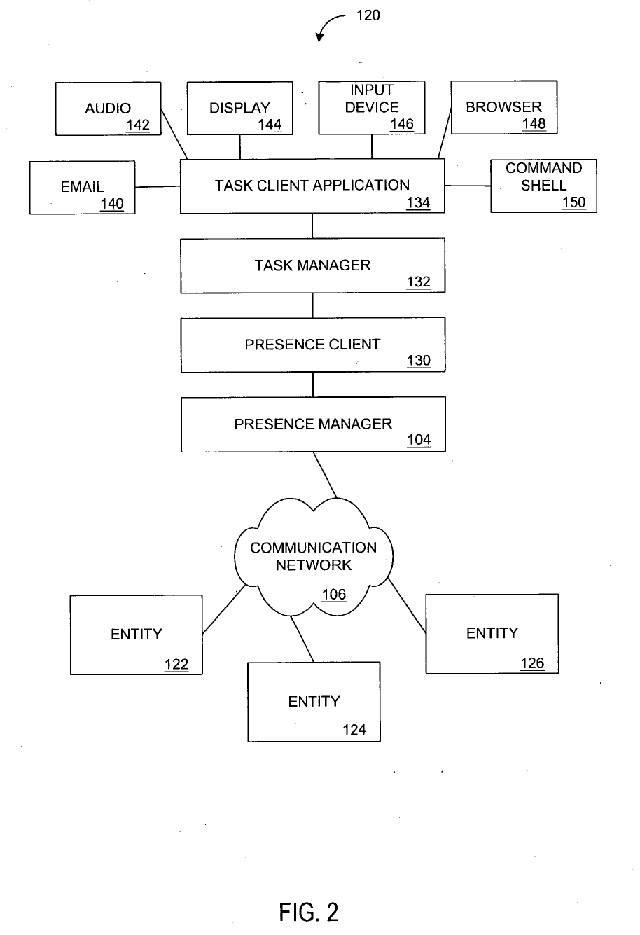

Now referring to FIG. 2, a system 120 is illustrated that may be used in some embodiments. The system 120 includes three entities 122, 124, 126, each of which may have a presence client resident, operating, or installed on it. The presence manager 104 may monitor or keep track of the online presence status of the entities 122, 124, 126 (or their respective presence clients).

The system 120 also includes a presence client 130 that is associated with task manager 132 and task client application 134. The presence client 130 determines the presence of one or more entities (e.g., the entities 122, 124, 126) from the presence manager 104 and passes the information to the task manager 132, thereby acting as an intermediary between the task manager 132 and the presence manager 104. In addition, the presence client 130 may make its presence known to the presence manager 104.

The task manager 132 performs the task or action management activities associated with the system 120. That is, the task manager 132 determines what actions are associated with what rules or otherwise need to be initiated by comparing the presence information provided by the presence client 130 regarding one or more entities. Users may provide information to the task manager 132 regarding rules or related actions. Alternatively, in some embodiments, a user may provide information to a database or other device, application, etc. that can provide the information to the task manager 132 or that can be accessed by the task manager 132 to acquire or determine the rule and/or action information (e.g., the task manager 132 may provide a user-interface through which end-user may define the rules, the same may also be accomplished by means of a web-based interface that allows the user to submit rules related information to the task manager or some intermediate application or database). In some other embodiments, the task client 134 may provide the additional functionality of a front-end application through which the user can submit rules related information to the task manager 132 or some intermediate application or database. In some embodiments, the task manager 132 may include a database or database application in which information regarding entities, rules and/or actions are stored.

When the task manager 132 determines that a rule is satisfied or that an action needs to be initiated, the task manager 132 notifies the task client application 134. In addition, the task manager 132 may provide information to the task client application regarding the entity, entity presence, rule, and/or action. The task client application 134 may start the action or instruct another device, application, etc. to start the action. For example, in some embodiments, the task client application 134 may interact or communicate with one or more subsystems, devices, applications, etc. such as email application or system 140, audio output device 142, display or monitor 144, input device 146, browser 148, and/or command shell 150. For example, the task client application 134 may launch browser 148 using a designated URL provided by the task manager 132 and which may be associated with a specific rule or action. As another example, the task client application 134 may send an email notification via email subsystem 140 using one or more email addresses, headings, messages, etc. provided by the task manager 134 and which may be associated with a specific rule or action. As a third example, the task client application 134 may send an instruction to a device causing a message to be provided audibly or visually by the device.

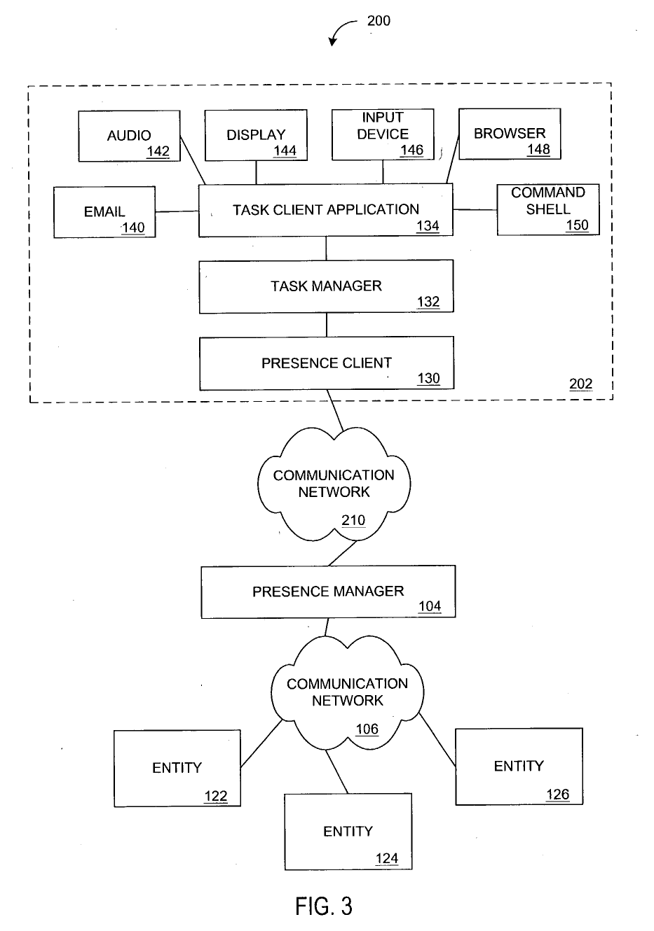

Now referring to FIG. 3, a system 200 is illustrated that may be used in some embodiments of the present invention. A client or user device (e.g., computer, PDA, cellular telephone) 202 may implement the components 130, 132, 134, 140, 142, 144, 146, 148, and/or 150 and some or all of the components 140, 142, 144, 146, 148, 150 may not be used. In the system 200, the task manager 132 takes on the task management requirements of only one device, e.g., the device 202. The task client application 134, task manager 132, and/or presence client 130 may be configured or implemented specifically for the device 202 or in a way tailored to the capabilities, functions, resource limitations, and/or features of the device 202.

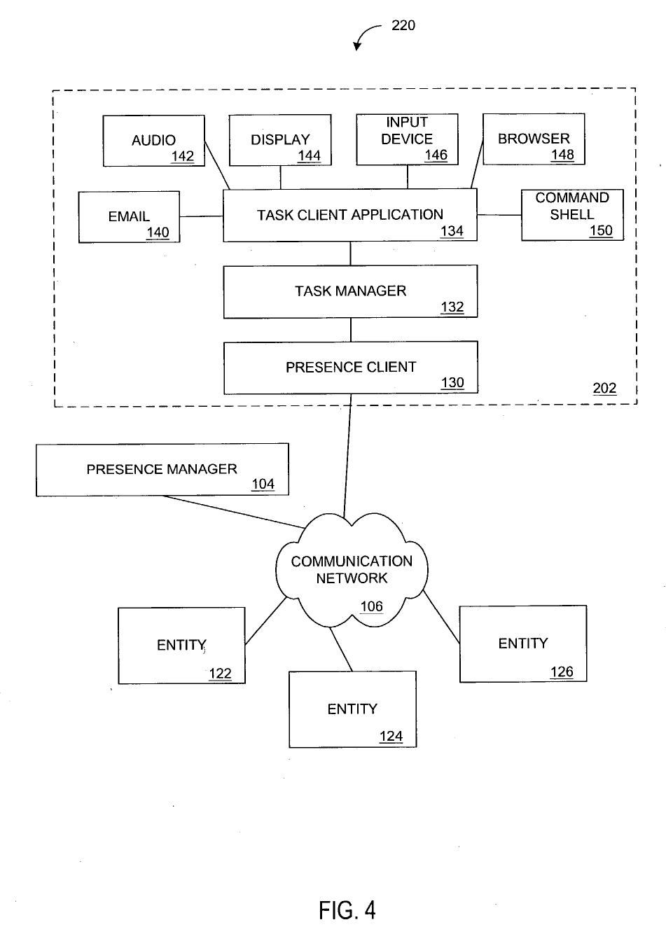

In some embodiments, the presence client 130 in the device 202 may communicate with the presence manager 104 via a communication network 210. In other embodiments, the presence client 130 in the device 202 may communicate with the presence manager 104 via the communications network 106, as illustrated by system 220 in FIG. 4.

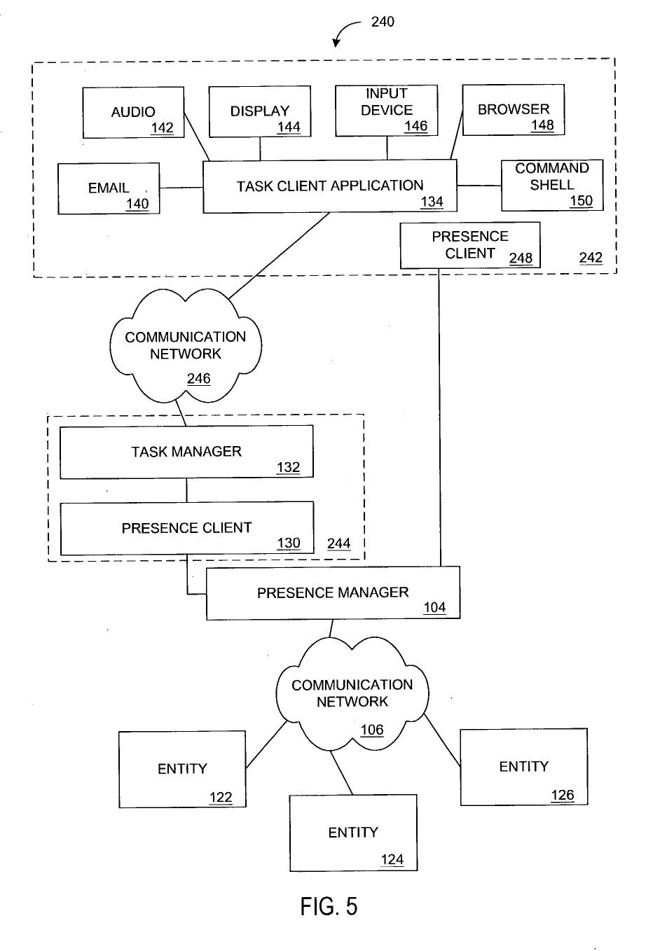

Now referring to FIG. 5, system 240 illustrates another embodiment of the present invention. The system 240 is particularly well suited when the task manager 132 is coordinating actions and rules associated with multiple entities. As opposed to the system 200 illustrated in FIG. 3 that is more of a device centric deployment, the system 240 is more of a network centric deployment. More specifically, the task client application 134 and none, some, or all of the components 140, 142, 144, 146, 148, 150 may be resident, installed, or operating on a user or client device 242 while the presence client 130 and the task manager 132 may resident, installed, or operating on another device 244 (e.g., a network server) and may communicate with the task client application 134 via communication network 246 and/or the presence manager 104.

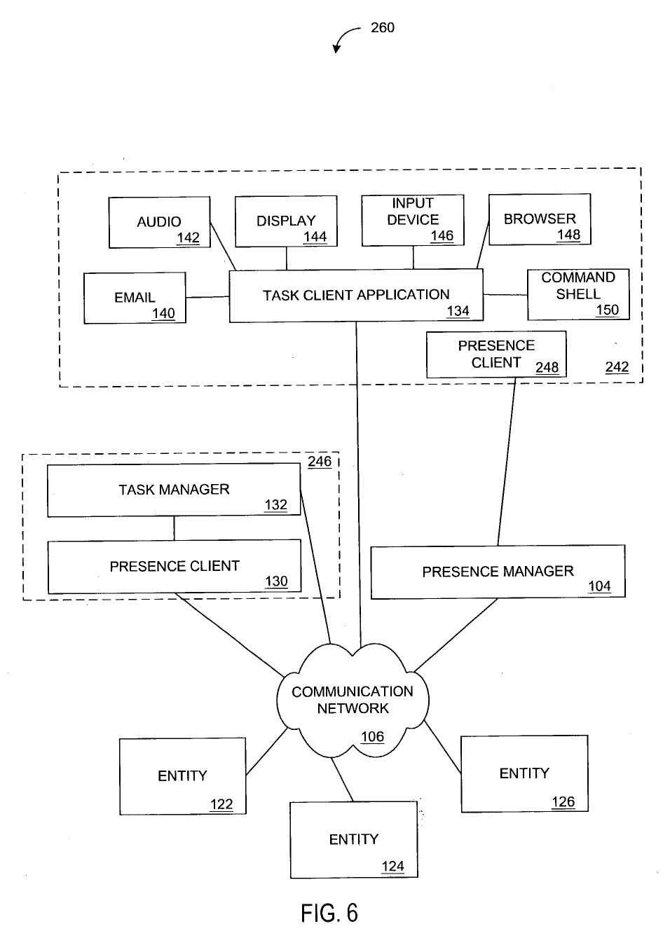

In some embodiments, the client or user device 242 may include optional presence client 248 if the client or user device 242 is to communicate directly with the presence manager 104. Also in some embodiments, the presence manager 104 may be resident, installed, or operating on the device 244 along with the task manager 132 and presence client 130 or it can be deployed on a separate device (e.g., a server owned or operated by a third party service provider). In some embodiments, only one communication network 106 might be used, as illustrated by system 260 in FIG. 6.

Process Description

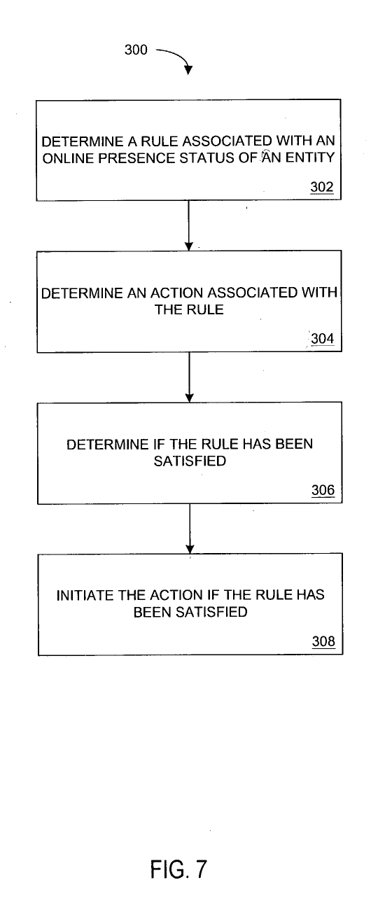

Reference is now made to FIG. 7, where a flow chart 300 is shown which represents the operation of a method in accordance with the present invention. The particular arrangement of elements in the flow chart 300 is not meant to imply a fixed order to the steps; embodiments of the present invention can be practiced in any order that is practicable. In some embodiments, some or all of the steps of the method may be completed by a single device, such as the device 202 of FIGS. 3 and 4, or one or more software applications or processes resident, installed, or operating on the device.

Processing begins at a step 302 during which a rule is determined that is associated with the online presence status of an entity. For example, in some embodiments, a task manager or other application, device, etc. may receive, retrieve, or access information regarding one or more rules associated with one or more entities. Some or all of the rule information may have been defined, stored in a database, or otherwise provided by one or more users. As previously discussed above, in some embodiments, a rule may be associated with more than one entity and/or the online presence status of more than one entity may be associated with a single rule.

In some embodiments, determining a rule may include receiving, retrieve, accessing, or otherwise determining information associated with the rule or an action associated with the rule. For example, rule or action related information may include such things as email addresses, telephone numbers, messages, URLs, routing information, entity identifiers, application or device settings or identifiers, electronic addresses, etc. that may be used in initiating an action when the rule is satisfied or otherwise used when completing the action.

During a step 304, an action is determined that is associated with the rule. In some embodiments, determining a rule during the step 302 may include determining an action associated with the rule. Thus, in some embodiments, the step 304 may be included in the step 306. In some embodiments, a task manager or other application, device, etc. may receive, retrieve, or access information regarding one or more actions associated with one or more rules. Some or all of the action information may have been defined, stored in a database, or otherwise provided by one or more users. In some embodiments, an action may be associated with more than one rule, and vice versa.

During a step 306, a determination is made as to whether or not the rule determined during the step 302 has been satisfied. In some embodiments, the step 306 may occur prior to the step 304. As the rule is based, at least in part, on the online presence status of one or more entities, in some embodiments the step 306 may include receiving, retrieving, or otherwise obtaining or determining information regarding the online presence status of the one or more entities. In some embodiments, the online presence status of an entity may include or be an online presence of the entity; an absence of an online presence of the entity, a change of the entity from an online presence to an absence, or a change of the entity from absence to an online presence.

In some embodiments, one or more of the steps 302, 304, 306 may be initiated or conducted only after such online presence status information for the entity is received, retrieved, or otherwise obtained or determined (e.g., after the presence client 130 receives presence status information regarding the entity 126, after the task manager 132 receives presence status information regarding the entity 126 from the presence client 130). In some embodiments, determining an online presence or status of an entity and/or determining if a rule has been satisfied may include determining or establishing an identifier for the entity.

In some embodiments, a rule may be based on more than the online presence status of the entity. For example, a rule might require that an entity be online on a certain day or at a certain location (e.g., GPS coordinate, ZIP code) to be satisfied. As another example, a rule may require that an entity be absent from an online presence for at least twenty minutes before the rule is satisfied. As a third example, a rule might require that at least two different entities be present online within a designated time window before the rule is satisfied.

During a step 308, the action determined during the step 304 is initiated assuming that the rule determined during the step 304 has been satisfied. As previously discussed above, in some embodiments an action may include one or more of the following: display of a prompt or message to an entity or user; initiation or playing of a beep, sound, or tone; initiation of a user-defined or other pre-specified task or action on a device or in a network; launching, pausing, resuming, or stopping of an application on a device; dialing of a telephone number, sending of a message (e.g., an email message, an instant message, SMS, EMS, MMS message) with or without a user defined or otherwise pre-specified address; starting of browser software with or without a user defined or otherwise pre-specified URL; switching of a device to a particular mode or configuration; activating or setting a specific profile, setting, or feature on a device or application; enabling or disabling or one or more menus or commands; starting, stopping, pausing, or resuming a download, database query, file transfer, etc.; or some other activity.

In some embodiments, a task client application (e.g., the task client application 134) may initiate the action. Alternatively, in some embodiments, a task manager (e.g., the task manager 132) may initiate the action by providing information to the task client application. The information may include data indicative of the rule, the action, the entity, the entity's online presence status, and/or the results of determinations made during one or more of the steps 302, 304, 306.

In some embodiments, the step 302 may include or be associating a rule with an online presence status of an entity. In some embodiments, association of a rule with an entity may include or be receiving, retrieving, or accessing information regarding one or more rules associated with one or more entities. Similarly, in some embodiments, the step 304 may include or be associating an action with the rule. In some embodiments, association of an action with a rule may include or be receiving, retrieving, or accessing information regarding one or more actions associated with one or more rules.

Client Device

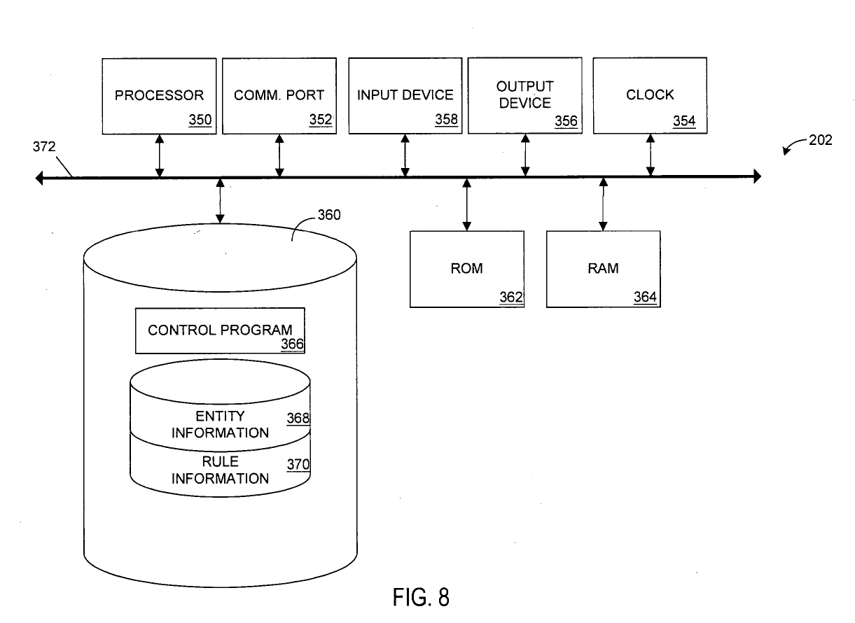

Now referring to FIG. 8, a representative block diagram of a user or client device 202 is illustrated. As previously discussed above, in some embodiments the client device 202 may include the task client application 134, the task manager 132, and/or the presence client 130 along with one or more of the subsystems 140, 142, 144, 146, 148 and/or 150.

The client device 202 may include a processor, microchip, central processing unit, or computer 350 that is in communication with or otherwise uses or includes one or more communication ports 352 for communicating with user devices and/or other devices. Communication ports may include such things as local area network adapters, wireless communication devices, Bluetooth technology, etc. The client device 202 also may include an internal clock element 354 to maintain an accurate time and date for the client device 202, create time stamps for communications received or sent by the client device 202, etc.

If desired, the client device 202 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the client device 202 may include a memory or data storage device 360 to store information, software, databases, communications, device drivers, rules, action information, etc. The memory or data storage device 360 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The client device 202 also may include separate ROM 362 and RAM 364.

The processor 350 and the data storage device 360 in the client device 202 each may be, for example: (i) located entirely within a single computer or other computing device; or (ii) connected to each other by a remote communication medium, such as a serial port cable, telephone line or radio frequency transceiver. In one embodiment, the client device 202 may comprise one or more computers that are connected to a remote server computer for maintaining databases.

A conventional personal computer or workstation with sufficient memory and processing capability may be used as the client device 202. The client device 202 may be capable of high volume transaction processing, performing a significant number of mathematical calculations in processing communications and database searches. A Pentium™ microprocessor, such as the Pentium III™ or IV™ microprocessor manufactured by Intel Corporation, may be used for the processor 350. Equivalent or alternative processors are available from Motorola, Inc., AMD, or Sun Microsystems, Inc. The processor 350 also may comprise one or more microprocessors, computers, computer systems, etc.

Software may be resident and operating or operational on the client device 202. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 furthermore includes program elements that may be necessary, such as an operating system, a database management system and device drivers for allowing the processor 350 to interface with peripheral devices, databases, etc. Appropriate program elements are known to those skilled in the art, and need not be described in detail herein.

The client device 202 also may include or store information regarding users, user devices, entities, rules, actions, communications, etc. For example, information regarding one or more entities may be stored in a entity information database 368 for use by the client device 202 or another device or entity. Information regarding one or more rules may be stored in a rule information database 370 for use by the client device 202 or another device or entity. In some embodiments, some or all of one or more of the databases may be stored or mirrored locally to or remotely from the client device 202.

According to an embodiment of the present invention, the instructions of the control program may be read into a main memory from another computer-readable medium, such as from the ROM 362 to the RAM 364. Execution of sequences of the instructions in the control program causes the processor 350 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 372.

While specific implementations and hardware/software configurations for the client device 202 has been illustrated, it should be noted that other implementations and hardware configurations are possible and that no specific implementation or hardware/software configuration is needed. Thus, not all of the components illustrated in FIG. 8 may be needed for a client device.

While the discussion of FIG. 8 has focused on the client device 202, in some embodiments the client device 242 may include some or all of the hardware/software components illustrated in FIG. 8. The client device 242 may include the task client application 134 along with one or more of the subsystems 140, 142, 144, 146, 148 and/or 150. However, as the task manager 132 typically may store the rule and action related information, in some embodiments the client device 242 might not include the rule information database 370 and/or the entity information database 368 illustrated in FIG. 8.

In some embodiments, a network server or other device also may include some or all of the hardware/software components illustrated in FIG. 8. For example, the network server or device 244 may include the task manager 132 and the presence client 130 along with some or all of the hardware/software components illustrated in FIG. 8.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques and languages as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed:

1. An apparatus, comprising:
a task client application, said task client application adapted to initiate an action upon receipt of information regarding said action;
a presence client, said presence client capable of receiving presence status information regarding an entity; and
a task manager in communication with said task client application and said presence client, said task manager having access to at least one rule associated with said entity's presence status, being capable of determining when said rule is satisfied, and being capable of providing information regarding said action to said task client application.

2. The apparatus of claim 1, further comprising:
a presence manager in communication with said presence client and capable of determining said entity's presence status and providing said presence status information to said presence client.

3. The apparatus of claim 1, wherein said information regarding said action includes data indicative of said entity.

4. The apparatus of claim 3, wherein said information regarding said action includes data indicative of said rule.

5. The apparatus of claim 1, further comprising:
a subsystem in communication with said task client application and adapted to receive information from said task client application regarding said action.

6. The apparatus of claim 1, wherein said task manager is adapted to receive data indicative of said rule from a user.

7. The apparatus of claim 1, wherein said task manager is adapted to retrieve data indicative of said rule.

8. The apparatus of claim 1, wherein said online presence status of said entity includes one of the following:
online presence of said entity; and
absence of an online presence of said entity.

9. The apparatus of claim 1, wherein said online presence status of said entity includes one of the following:
a change of said entity from online presence to absence; and
a change of said entity from absence to online presence.

10. The apparatus of claim 1, wherein said rule is associated with online presence statuses of multiple entities.

11. An apparatus, comprising:
a presence client, said presence client capable of receiving presence status information regarding an entity; and
a task manager in communication with a task client application and said presence client, said task manager having access to at least one rule associated with said entity's presence status, being capable of determining when said rule is satisfied, and being capable of providing said information regarding said action to said task client application.

12. The apparatus of claim 11, wherein said task client application is capable of initiating said action upon receipt of said information regarding said action from said task manager.

13. A method for facilitating an action based on an entity's online presence status, comprising:
determining a rule associated with an online presence status of an entity;
determining an action associated with said rule;
determining if said rule has been satisfied; and
initiating said action if said rule has been satisfied.

14. The method of claim 13, wherein said determining a rule associated with an online presence status of an entity includes at least one of the following
receiving data from a user indicative of said rule; and
retrieving data indicative of said rule.

15. The method of claim 13, wherein said wherein said determining an action associated with said rule includes at least one of the following:
receiving data from a user indicative of said action; and
retrieving data indicative of said action.

16. The method of claim 13, wherein said determining if said rule has been satisfied includes determining if online presence status of said entity associated with said rule has been satisfied.

17. The method of claim 13, further comprising:
receiving information regarding said online presence status of said entity.

18. The method of claim 13, wherein said online presence status of said entity includes one of the following:
online presence of said entity;
absence of an online presence of said entity;
a change of said entity from online presence to absence; and
a change of said entity from absence to online presence.

19. The method of claim 13, wherein said initiating said action includes providing information to a task client application capable of initiating said action.

20. The method of claim 19, wherein said information includes at least one of the following:
data indicative of said rule;
data indicative of said action;
data indicative of said entity; and
data indicative of said online presence status of said entity.

21. A method for facilitating an action based on an entity's online presence status, comprising:
associating a rule with an online presence status of an entity;
associating an action with said rule;
determining that said rule has been satisfied; and
initiating said action if said rule has been satisfied.

22. A system for facilitating an action based on an entity's online presence status, comprising:
a memory;
a communication port; and
a processor connected to said memory and said communication port, said processor being operative to:
determine a rule associated with an online presence status of an entity;
determine an action associated with said rule;
determine if said rule has been satisfied; and
initiate said action if said rule has been satisfied.

23. A computer program product in a computer readable medium for facilitating an action based on an entity's online presence status, comprising:
first instructions identifying a rule associated with an entity's online presence status
second instructions for identifying an action associated with said rule;
third instructions for establishing whether or not said rule has been satisfied; and
fourth instructions for instigating said action if said rule has been satisfied.
